(19) United States
(12) Patent Application Publication
(10) Pub. No.: US 2026/0057789 A1
(43) Pub. Date: Feb. 26, 2026

(54) CONTEXTUALLY BOOSTED AVIATION SPEECH RECOGNITION

(71) Applicants: Paul W. Johnston, Duluth, MN (US); Andrew Dale Johnson, Duluth, MN (US); Vijay Bhaskar Venkataraman, Excelsior, MN (US)

(72) Inventors: Paul W. Johnston, Duluth, MN (US); Andrew Dale Johnson, Duluth, MN (US); Vijay Bhaskar Venkataraman, Excelsior, MN (US)

(21) Appl. No.: 19/304,916

(22) Filed: Aug. 20, 2025

Related U.S. Application Data
(60) Provisional application No. 63/685,576, filed on Aug. 21, 2024.

(51) Int. Cl. G08G 5/34; G08G 5/21; G08G 5/24; G10L 15/08; G10L 15/22

(52) U.S. Cl. CPC G08G 5/34; G08G 5/21; G08G 5/24; G10L 15/08; G10L 15/22; G10L 2015/088; G10L 2015/223

(57) ABSTRACT

A variety of applications can include a system having a speech recognition system responsive to the speech input, where the speech recognition system can be configured to recognize the speech input using an aviation vocabulary including words extracted using state information of an aircraft or intent information of the aircraft associated with the received speech input. A control system can be implemented to automatically perform an action in the system in response to analysis of the recognized speech input, where the action is associated with flight of the aircraft.

### CLAIM OF PRIORITY

This application claims the priority benefit of U.S. Provisional Application Ser. No. 63/685,576, filed 21 Aug. 2024, entitled “CONTEXTUALLY BOOSTED AVIATION SPEECH RECOGNITION,” which application is incorporated herein by reference in its entirety.

### FIELD OF THE DISCLOSURE

Embodiments of the disclosure relate generally to systems and, more specifically, to systems having aviation speech recognition.

### BACKGROUND

Automatic speech recognition (ASR) models are utilized to transcribe spoken messages into text and extract the meaning. ASR models are trained on extensive datasets comprising general language usage. ASR engines operating on such ASR models are trained based on general speech patterns. However, accurate speech recognition of aviation speech is difficult due to aviation vocabulary being different from vocabulary generated from standard speech.

### BRIEF DESCRIPTION OF THE DRAWINGS

The drawings, which are not necessarily drawn to scale, illustrate generally, by way of example, but not by way of limitation, various embodiments discussed in the present document.

FIG. 1 illustrates an example scenario for boosting of call signs of aircraft within a radius of Superior, Wisconsin airport, in accordance with various embodiments.

FIG. 2 is a representation of an example scenario for flight of an aircraft showing landmarks associated with an entered flight plan for the aircraft, in accordance with various embodiments.

FIG. 3 illustrates an example scenario for boosting of call signs of aircraft within a radius of Duluth airport for aircraft, in accordance with various embodiments.

FIG. 4 reflects an example scenario for boosting as an aircraft approaches an airspace, in accordance with various embodiments.

FIG. 5 illustrates example contextual biasing mechanisms for several aviation situations, in accordance with various embodiments.

FIG. 6 is a representation of an example flight plan providing word boost for enhanced voice recognition to improve aviation speech recognition, in accordance with various embodiments.

FIG. 7 is a flow diagram of features of an example method of operating a speech recognition system, in accordance with various embodiments.

FIG. 8 is a flow diagram of an example method of using speech recognition in an aviation system, in accordance with various embodiments.

FIG. 9 illustrates an example aviation system having a speech recognition subsystem that can be enhanced using state information of an aircraft or intent information of the aircraft, in accordance with various embodiments.

FIG. 10 depicts a block diagram of features of an example system operable to control its operation in conjunctions with a speech recognition unit, in accordance with various embodiments.

### DETAILED DESCRIPTION

The following detailed description refers to the accompanying drawings that show, by way of illustration, various embodiments that can be implemented. These embodiments are described in sufficient detail to enable those of ordinary skill in the art to practice these and other embodiments. Other embodiments can be utilized, and structural, logical, mechanical, and electrical changes can be made to these embodiments. The various embodiments are not necessarily mutually exclusive, as some embodiments can be combined with one or more other embodiments to form new embodiments. The following detailed description is, therefore, not to be taken in a limiting sense.

ASR models trained on aviation speech encounter accuracy challenges due to the frequent inclusion of aviation-related statements not commonly found in general natural language datasets and aviation language datasets. Aviation speech often includes infrequently used words or names with contextual relevance limited to specific locations or aircraft states. Such words or names would include items such as navigational locations and aircraft call signs. These seldom utilized words are typically found in various aviation databases. Through additional training on aviation common language datasets, transfer learning may facilitate the refinement of ASR models to enhance their recognition of aviation speech. However, training an aviation language model on all these words does not yield the desired level of accuracy due to their infrequent usage. Further enhancements to ASR systems can provide for more robust speech recognition with less misrepresentations for aviation speech.

ASR models can be weighted to favor certain words or phrases, which are known as contextual biasing, or contextual word boosting. Contextual biasing has been shown to improve recognition of named entities such as contacts, locations, and film titles in general-use case ASR. By leveraging an aircraft's state information and intent information, seldom-used words or terms that are more likely to occur in the prevailing context can be identified, thereby substantially enhancing the accuracy of the aviation ASR model. These seldom-used words can be contextual-word boosted, which is the enhancing of weights associated with the seldom-used words for the given context.

In various embodiments, aviation speech recognition can be enhanced using word boosting based on state information and intent information for a given aircraft. There are many words encountered during an aviation flight that are particular to the flight that would be difficult for a normal speech algorithm to accurately recognize, especially aviation terms that are related to aviation locations that only have context to a local geographical region. In an approach tailored to a flight of an aircraft, aviation words can be extracted from a number of sources, where the aviation words may be encountered during aircraft flight to boost the recognition of these words by a speech recognition algorithm. The set of extracted words can contain names of aviation locations along the flight path that can be used by the aircraft operating along the flight path or by air traffic control (ATC) that monitors the flight of the aircraft. The set of extracted words can contain the call sign of the aircraft executing the flight of the flight plan and variations of the call sign.

The boosted words can be generated in flight or prior to flight from state information and intent information of the aircraft for a specified flight with respect to location regions of the flight of the aircraft. State information can include a particular condition of the respective aircraft. For example, state information can include, but is not limited to, the current location of the aircraft in flight, a selected radio frequency of the aircraft in flight, geographical positioning information, or heading of the aircraft in the flight. Intent information can include information associated with planning or managing the flight. Intent information can include, but is not limited to, a specific flight plan for the flight of the aircraft. State and intent information can be scraped from a number of different sources. Data scraping, which is a processing mechanism to extract data from a target location and transfer the data into a database-like structure for electronic processing, can be used to provide data from the different sources to a storage structure to be used by a speech recognition algorithm of an ASR system.

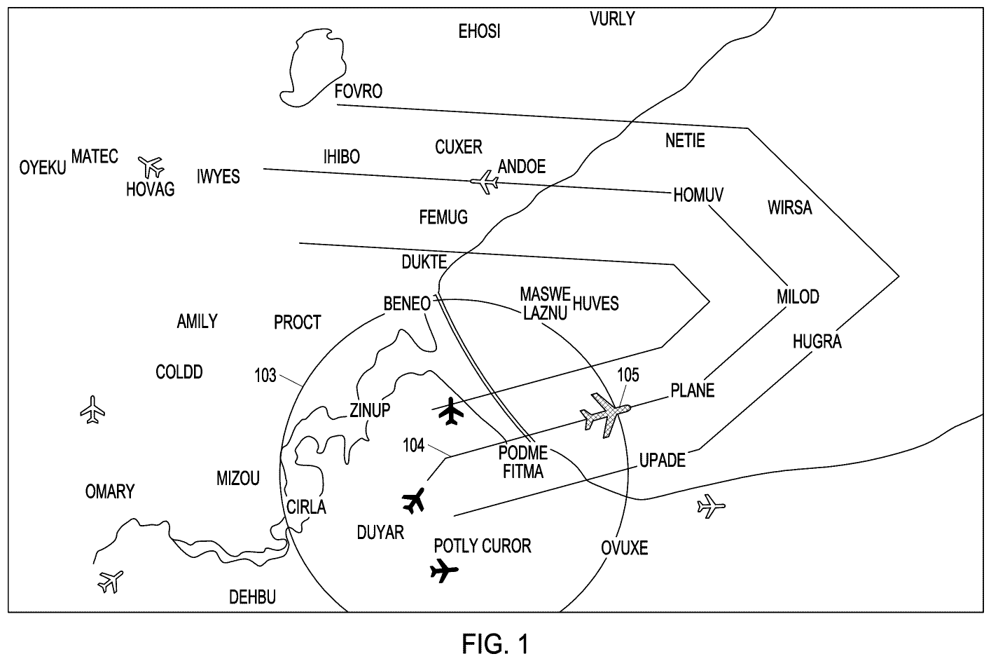

FIG. 1 illustrates an embodiment of an example scenario for boosting of call signs of aircraft within a region 103 defined by a radius of Superior, Wisconsin airport (SUW) 104. Frequency of aircraft 105 tuned to SUW area Common Traffic Advisory Frequency (CTAF) can allow for the boosting of the call signs of aircraft within some radius of SUW 104 as identified from automatic dependent surveillance-broadcast (ADS-B) data. CTAF is a frequency designated for manned aircraft pilots to communicate with each other directly, air-to-air, while operating to or from an airport without interfacing with an operating control tower. By utilizing aircraft state information such as current location, ADS-B data can be used to identify nearby aircraft and their call signs. This data in context of the current location of aircraft 105 can enable the boosting of the call signs of the nearby aircraft for improved recognition in aircraft 105. The ADS-B can be data scraped in real-time in an ASR system in aircraft 105.

By utilizing aircraft state information such as a selected radio frequency, items associated with the selected frequency can be boosted to improve speech recognition. For instance, the names of airport facilities can be boosted when a ground control frequency is selected. Items associated with an Automatic Terminal Information Service (ATIS) transmission can be boosted when an ATIS frequency is selected. ATIS is a continuous broadcast service of information related to an airport, which can be accessed in an aircraft in flight. The information is pre-recorded with aeronautical information that pertains to weather conditions and other weather information, active runways, available approaches, and important notices to the pilot in command of an aircraft.

By utilizing an aircraft's intent information such as its flight plan, the names of navigational locations proximate to the intended flight path can be extracted from various databases enabling the boosting of the names for improved speech recognition. A flight plan is documentation used for flight of an aircraft to assist in navigation and appropriate operation of the aircraft. There are a number of types of flight plans. Flight plans can include visual flight rules (VFR) flight plans, instrument flight rules (IFR) flight plans, composite flight plans, defense VFR flight plans, and international flight plans. The documents can have a format with various entities identified in specific locations of the document, effectively defining the entities. In an electronic format of the flight plan document, the specified locations can be presented as known fields of an electronic format.

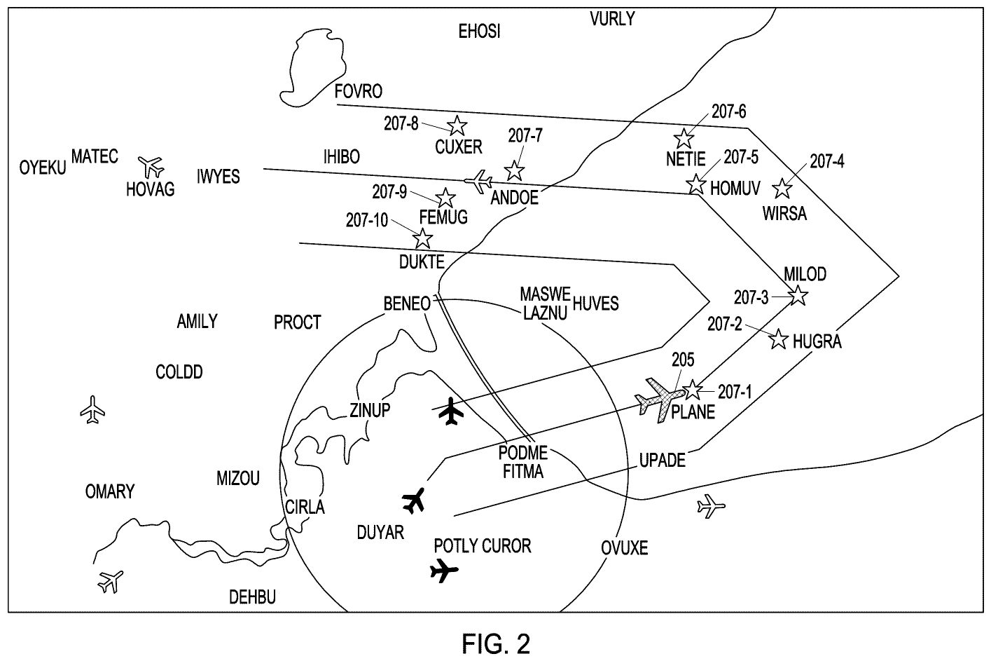

FIG. 2 is a representation of an embodiment of an example scenario for flight of an aircraft 205 showing landmarks 207-1, 207-2 . . . 207-11 associated with an entered flight plan for the aircraft 205. Landmarks 207-1, 207-2 . . . 207-11 or other fixed locations along the way of the entered flight plan can be boosted in an ASR system of aircraft 205, which can include a visual identification of landmarks 207-1, 207-2 . . . 207-11 or other fixed locations on a screen in aircraft 205 or provided in an audio list in aircraft 205. Landmarks 207-1, 207-2 . . . 207-11 can be dropped off the screen or the audio list as aircraft 205 passes the respective landmark. The drop-off on the screen can be realized by a dimming of the graphical presentation on the screen or changing the color of the graphical presentation.

Utilizing aircraft state information such as global positioning system (GPS) information or other position information, the names of navigational locations proximate to the current aircraft position of an aircraft can be extracted from various databases enabling the boosting of the names for improved speech recognition. The extraction from various databases can be performed in real time as the aircraft is in flight using the communications of the aircraft with the GPS source.

Utilizing aircraft state information such as heading, the names of navigational locations proximate to the current heading and position of an aircraft in flight can be extracted from various databases enabling the boosting of the names for improved speech recognition in the aircraft. The extraction from various databases can be performed in real time as the aircraft is in flight using the communications of the aircraft.

Utilizing aircraft information such as type of aircraft information, the identification of aircraft manufacturer can be boosted for improved speech recognition of call signs. Utilizing the aircraft information such as N-number, the phonetics and numerals in a particular order can be used to bias a system for improved speech recognition of call signs.

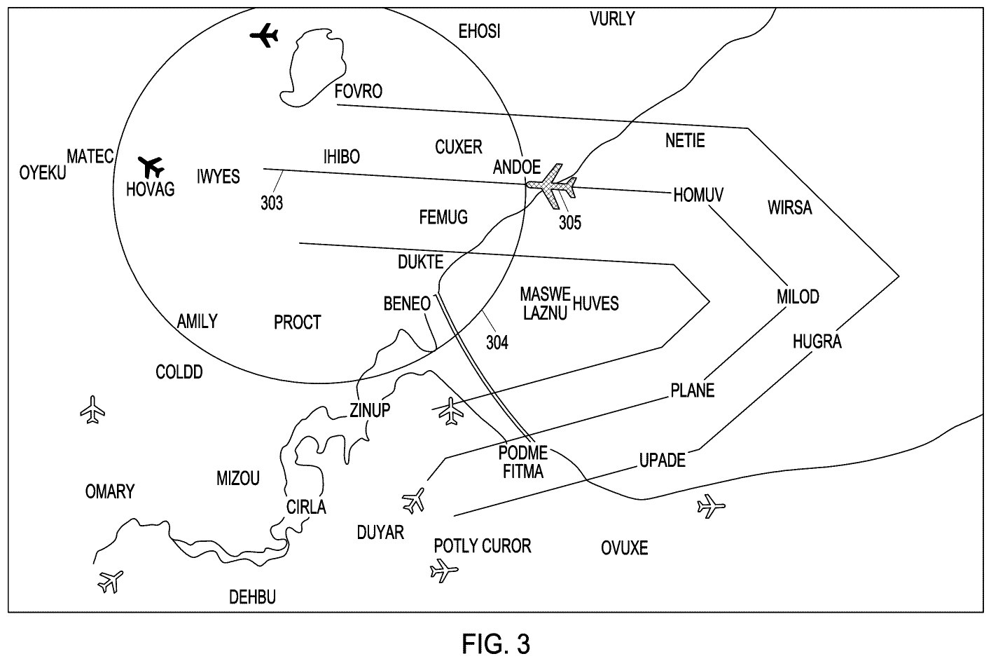

FIG. 3 illustrates an embodiment of an example scenario for boosting of call signs of aircraft within region 304 defined by a radius of Duluth airport (DLH) for aircraft 305. Within the communications system of aircraft 305, by tuning to DLH approach, call signs of aircraft within region 304 of DLH as identified from ADS-B can be boosted.

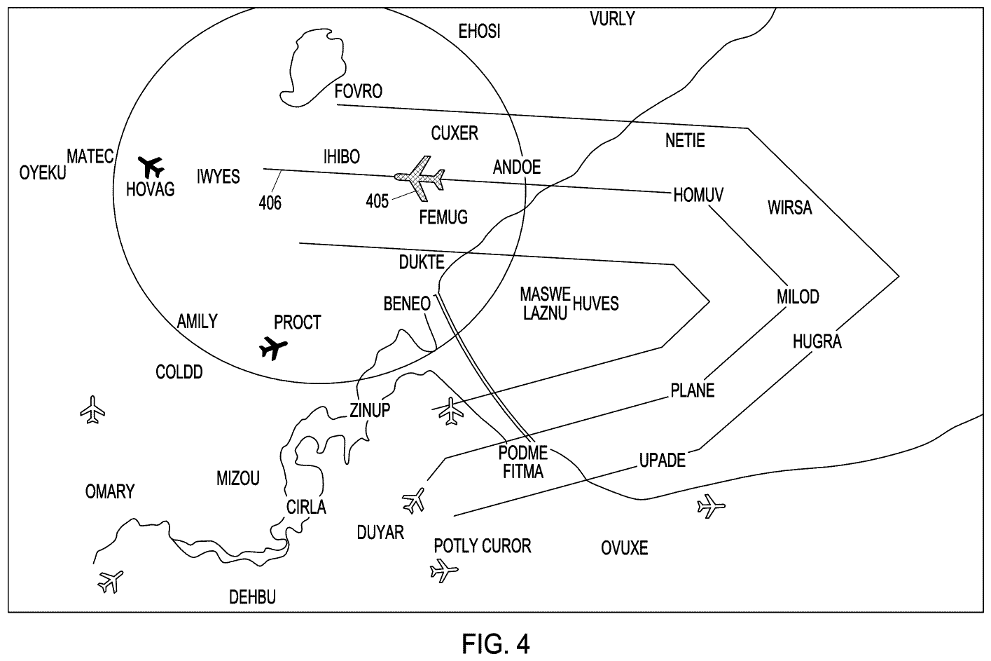

FIG. 4 reflects an embodiment of an example scenario for boosting as an aircraft 405 approaches an airspace defined by location 406. Upon tuning the communication system of aircraft 405 to the tower frequency associated with the airspace defined by location 406, words and phrases like “runway two seven” and “cleared to land” can be boosted.

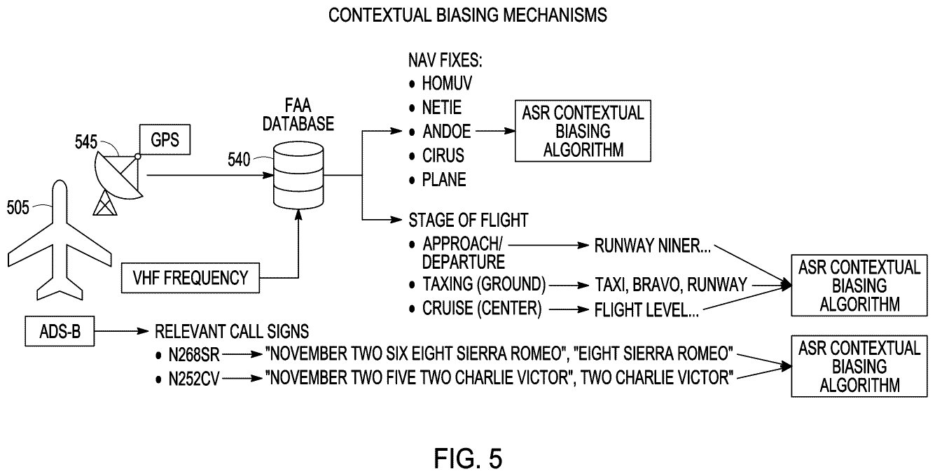

FIG. 5 illustrates an embodiment of example contextual biasing mechanisms for several aviation situations. An ASR contextual biasing algorithm can operate on data for an aircraft 505 that can access a database 520, such as, but not limited to, a Federal Aviation Administration (FAA) database, for data regarding local regions correlated to flight of aircraft 505. Database 520 or other storage apparatus can include “Digital-Terminal Procedures Publication (d-TPP)/Airport Diagrams” published by the FAA. These publications are graphical pdf documents that provide pilots with information on how to approach an airport. An ASR system of aircraft 505 can obtain and share data with database 520 regarding the state of aircraft such as a very high frequency (VHF) frequency used by aircraft 505 and positional information from GPS data. Aircraft 505 can also obtain ADS-B data for use by the ASR of aircraft 505.

An ASR contextual biasing algorithm for the ASR system of aircraft 505 can operate on a number of different types of data. The different types of data can include, but are not limited to, relevant call signs corresponding to the flight of aircraft 505, navigational fixes encountered in the flight, and different stages of the flight. With ADS-B providing information on relevant call signs, the audible phrase “November two six eight Sierra Romeo” can be processed by the ASR contextual biasing algorithm to be N268SR, and the audible phrase “November two five two Charlie Victor” can be processed by the ASR contextual biasing algorithm to be N252CV.

ASR contextual biasing algorithm can be used on speech input dealing with stages of flight of an aircraft. For example, with respect to approach and departure, “runway niner” can be processed to be runway 9. With respect to ground taxing, “taxi, bravo, runway” can be processed to be taxi to B runway. With respect to cruising, “flight level” can be processed to indicate flying on course. The vocabulary included in FIG. 5 are non-limiting examples of individual words that can be biased towards aviation terms.

ASR contextual biasing algorithms can be used on speech input dealing with navigational fixes, which include navigational fixes that are presented by non-traditional words. An ASR contextual biasing algorithm can be used to clarify for pilot locations having identification given by such terms as HOMUV, NETIE, ANDOE, CIRUS, and PLANE. In addition, the ASR contextual biasing algorithm can be applied to aviation terms identifying ground locations and locations in the sky.

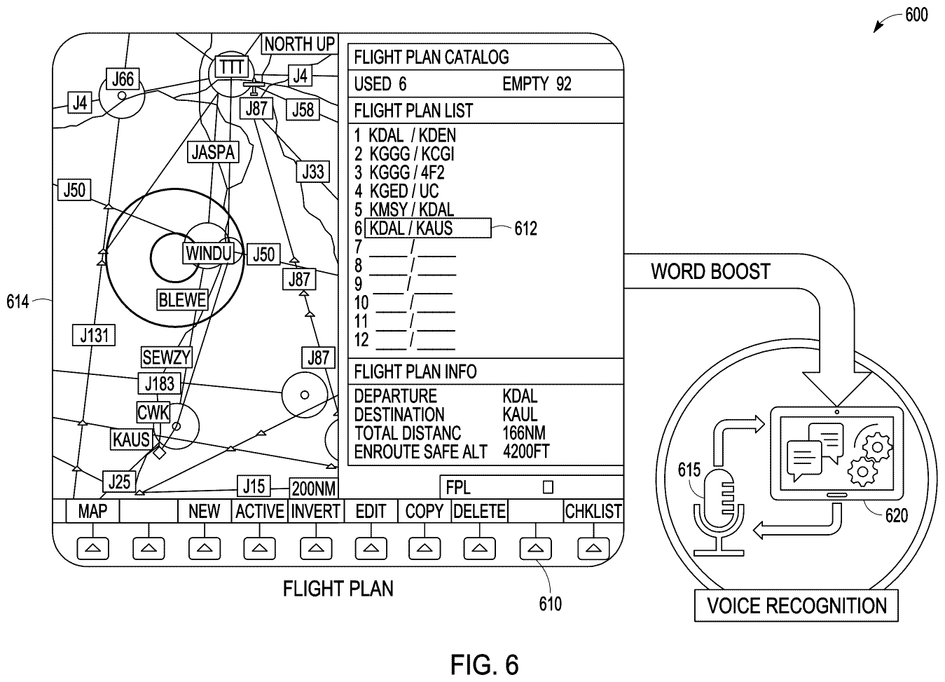

FIG. 6 is a representation 600 of an embodiment of an example flight plan 610 that can be word boosted for enhanced voice recognition to improve aviation speech recognition. Flight plan 610 can include a number of aviation-specific terms that are not standard to general vocabulary of a speech recognition algorithm. Flight plan 610 for an aircraft journey can include locations along a flight path. These locations can be identified by names specific to the local geographical region identified in the flight plan for the aircraft. For example, flight plan 610 provides the identification 612 of KDAL/KAUS as a departure location and destination location, respectively. KDAL and KAUS are not part of a standard vocabulary of a conventional speech recognition algorithm. These are International Civil Aviation Organization (ICAO) airport codes, rarely if ever, are pronounced as they are shown. Instead, the location or airport name that corresponds to the ICAO code will be pronounced. The letters in the code themselves may be pronounced more commonly as phonetics. Example: “KAUS→Alpha-Uniform-Sierra,” or “Austin Bergstrom airport.” The flight plan can include other words or labels associated with the flight plan. The flight plan can include words and labels referring to ground roads, such as but not limited to interstate highways within the region around the flight plan. The flight plan can include aviation words for crossing routes and alternate plans. The flight plan can include total distance between departure location and destination location. The fight plan can specify a safe altitude for the flight and projected weather conditions. In addition, an aircraft, associated with the flight plan, has a call name used in communication with an ATC center, which is also not part of a standard vocabulary of a conventional speech recognition algorithm. Further, an aviation vocabulary for use in flight of an aircraft can include other terms like “niner” meaning the number 9, “Charlie” for the letter C, “Romeo” for the letter R, and other similar terms.

With flight plan 610 provided as input to a speech recognition system 620, the location words and other data of flight plan 610 can be scraped from flight plan 610 and entered into a list or database structure of a speech recognition system 620, along with the call name of the aircraft for which the flight plan 610 is generated, which provides a flight specific or a flight customized language decoder for the particular flight defined by flight plan 610 for the given aircraft. This input provides a context based set of word to the list that may not already be known to existing language recognition software of speech recognition system 620. Flight plan 610 can also include a graphical representation 614 of the flight path of flight plan 610.

The various forms of data in flight plan 610 can be data scraped using one or more mechanisms for data scraping. Identification 612 can be a specific location in flight plan 610. In an electronic version of flight plan 610, identification 612 can be a data field. The data can include a filtered data set of collected named locations in a graphical representation 614 with respect to specific locations of the flight plan such as departure location and destination location to increase the probability that the words are recognized correctly on initial reception of the words in a speech input. The data scraping can be performed in speech recognition system 620 with flight plan 610 as an input, or data can be remotely scraped and transmitted to speech recognition system 620 over a communication network. Speech recognition system 620 can be implemented in an aircraft or at an ATC center.

With speech recognition system 620 boosted with words from flight plan 610, an audio transceiver 615 can be used to receive speech input and interact with speech recognition system 620. Audio transceiver 615 can be, but is not limited to, a microphone or VHF transceiver. Audio transceiver 615 can provide speech input to speech recognition system 620, which can recognize the speech input for analysis that can provide an automated response to the speech input. The automated response can include, but is not limited to, making recommendations for actions to be taken during the flight plan. The automated response can include displaying information on a screen in the aircraft or at an ATC center, depending on the location at which speech recognition system 620 is implemented. Though a flight plan is discussed with respect to FIG. 6, other data sources can be accessed for operation on by a contextually boosted aviation speech recognition system.

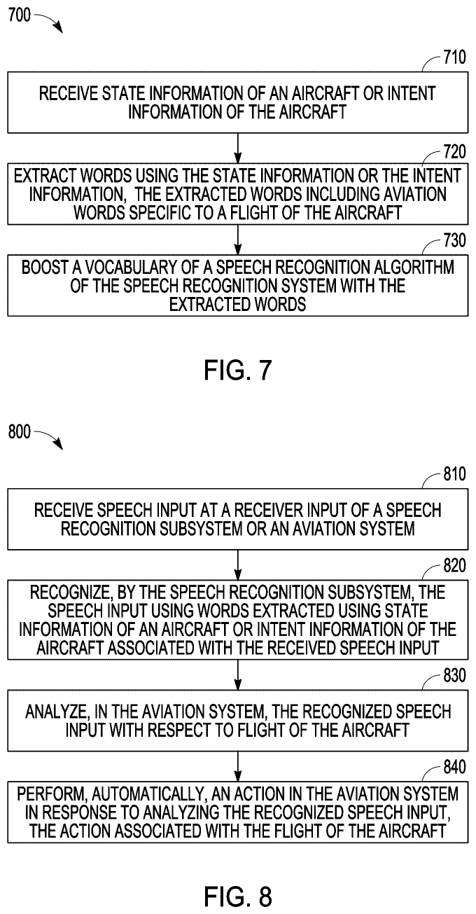

FIG. 7 is a flow diagram of features of an embodiment of an example method 700 of operating a speech recognition system. The operation of the speech recognition system in method 700 can be realized in automated machine activity using processors, storage devices or systems that include instructions, communication structures, and audio transceivers. At 710, state information of an aircraft or intent information of the aircraft is received. At 720, words are extracted using the state information or the intent information, where the extracted words include aviation words specific to a flight of the aircraft. At 730, a vocabulary of a speech recognition algorithm of the speech recognition system is boosted with the extracted words. The vocabulary can be boosted in an aviation system in the aircraft during the flight.

Variations of method 700 or methods similar to method 700 can include a number of different embodiments that may be combined depending on the application of such methods or the architecture of aviation systems that can implement actions based on contextually boosted aviation speech recognition for an aircraft. Such methods can include intent information in the form of a flight plan for the flight. Aviation locations along a path identified in the flight plan, a call sign of the aircraft, or call signs of other aircraft in a vicinity of a flight path of the flight plan can be extracted from the flight plan. Words can be extracted during the flight identifying a flight path for the aircraft and words identifying a region extending laterally from the flight path.

Variations of method 700 or methods similar to method 700 can include extracting words for identifying an alternative flight path for the aircraft different from a flight path specified in a flight plan. Variations can include adding data to the speech recognition system, where the data is information regarding one or more entities in a flight plan of the flight of the aircraft. The added words can boost the operational capability of the speech recognition system. The extracted words can include, but are not limited to, aviation locations along a path identified in the flight plan, a call sign of the aircraft corresponding to the flight plan, or variations to the call sign of the aircraft corresponding to the flight of the aircraft. The one or more entities can include, but are not limited to, locations off the flight path but in the local geographical region covered by the flight plan or terrestrial routes within the geographical region.

Data scraping of data sources can be performed for a region that extends laterally a distance in each direction from a centerline of the flight path. The lateral distance can be 20 miles or other distances. Alternatively, different lateral distances can be used in different directions from the centerline of the flight path. A list of words for the speech recognition can be modified in an ongoing and changing manner based on a circle defined by a radius extending from the aircraft in flight. In an approach to maintain the list of words and associated data dynamically, words can be added or dropped from the list as the aircraft moves.

Variations of method 700 or methods similar to method 700 can include automatically performing an action in the aviation system to control flight of the aircraft in response to analyzing the recognized speech input. Variations of using enhanced speech recognition in the aviation system for an aircraft can include making a recommendation affecting flight of the aircraft, by displaying the recommendation on a screen in the aircraft or by generating the recommendation audibly using a speaker in the aircraft. The aviation system can perform the recommendation in response to a signal to perform the recommendation. The signal can be a speech signal or an instrument-actuated signal. The aviation system can provide instructions to an autopilot system to control the aircraft in response to voice recognition. For example, the instructions can be instructions to fly to a specified location or change heading to a specific direction. The instructions can be instructions to avoid a specified location or specified heading. Variations can include altering the flight of the aircraft by a control system of the aircraft in response to speech recognition of a command based on the recommendation, where details of the altered flight are generated from words extracted from the flight plan.

FIG. 8 is a flow diagram of an embodiment of an example method 800 of using enhanced speech recognition in an aviation system. Operation of the aviation system in method 800 can be realized in automated machine activity using processors, storage devices or systems that include instructions, communication structures, audio transceivers, and other structural components of the aviation system. At 810, speech input is received at a receiver input of a speech recognition subsystem of an aviation system. At 820, the speech input is recognized by the speech recognition subsystem, using words extracted using state information of an aircraft or intent information of the aircraft associated with the received speech input. At 830, the recognized speech input is analyzed in the aviation system with respect to flight of the aircraft. At 840, an action in the aviation system is performed automatically in response to analyzing the recognized speech input, where the action is associated with the flight of the aircraft.

Variations of method 800 or methods similar to method 800 can include a number of different embodiments that may be combined depending on the application of such methods or the architecture of aviation systems that can implement actions based on contextually boosted aviation speech recognition for an aircraft. Such methods can include scraping data from a graphical representation of the flight plan or other data source to extract the words for contextual boosting. Variations can include boosting weights associated with the extracted words in a speech recognition algorithm of the speech recognition subsystem.

In variations of method 800 or methods similar to method 800, the extracted words can include aviation locations along a path identified in a flight plan, a call sign of the aircraft corresponding to the flight plan, or call signs of other aircraft within a specified radius about a selected location. In variations of method 800 or methods similar to method 800, the extracted words can include aviation locations in a local region in which a flight path for the aircraft is located, the flight path identified in a flight plan.

Variations of method 800 or methods similar to method 800 can include automatically performing an action in the aviation system to control flight of the aircraft in response to analyzing the recognized speech input. Variations can include making a recommendation affecting flight of the aircraft, by displaying the recommendation on a screen in the aircraft or by generating the recommendation audibly using a speaker in the aircraft. The recommendation can be performed in response to a signal to perform the recommendation, where the signal is a speech signal or an instrument-actuated signal. Variations can include altering the flight of the aircraft by a control system of the aircraft in response to speech recognition of a command based on the recommendation, where details of the altered flight are generated from words extracted from a flight plan, other intent information, or state information of the aircraft. The control system of the aircraft can provide instructions to an autopilot system to control the aircraft in response to voice recognition. For example, the instructions can be instructions to fly to a specified location or change heading to a specific direction. The instructions can be instructions to avoid a specified location or specified heading.

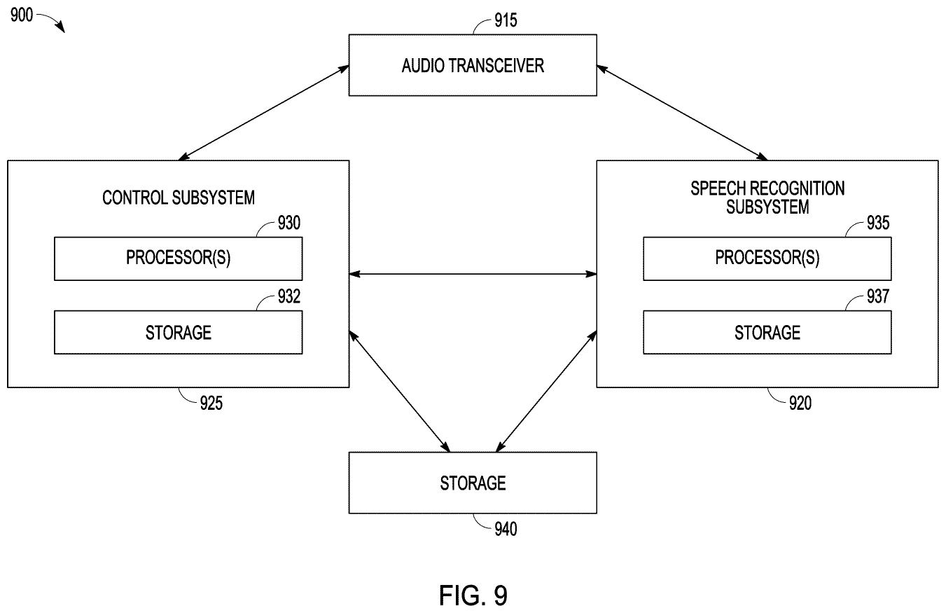

FIG. 9 illustrates an embodiment of an example aviation system 900 having a speech recognition subsystem 920 that can be enhanced using state information of an aircraft or intent information of the aircraft. Aviation system 900 can include audio transceiver 915 and control subsystem 925 that are operable with speech recognition subsystem 920. Audio transceiver 915 can be implemented to receive speech input and interface with speech recognition subsystem 920. Speech recognition subsystem can include one or more processors 935 and storage 937 that can be configured to recognize the speech input using aviation vocabulary including words extracted from state information of an aircraft or intent information of the aircraft associated with the received speech input. The extracted words can be specified in the state information or the intent information and can include non-standard general vocabulary. The extracted words can be stored in storage 937.

Control subsystem 925 can include one or more processors 930 and storage 932 to interface with audio transceiver 915 and speech recognition subsystem 920, where control subsystem 925 can be structured to automatically perform an action in aviation system 900 in response to analysis of the recognized speech input, where the action is associated with the flight of the respective aircraft. In addition to storage 932 and storage 937, aviation system 900 can include a storage 940 that can include data or instructions for control subsystem 925, speech recognition subsystem 920, or other components of aviation system 900. Storage 932, storage 937, and storage 940 can be realized by one or more machine-readable storage devices, such as computer-readable storage devices. A machine-readable storage device is a physical medium on which is stored one or more sets of data structures or instructions can be stored that can be utilized by a machine to perform any one or more of the techniques or functions for which the machine is designed. Storage 932 and storage 937 can be implemented by storage 940. Control subsystem 925 and speech recognition subsystem 920 can be realized as an integrated system.

Variations of aviation system 900 and its features, as taught herein, or similar systems can include a number of different embodiments and features that can be combined depending on the application of such aviation systems, the format of such aviation systems, or the architecture in which such aviation systems are implemented. Aviation system 900 can be an aviation system in an aircraft. Intent information can include, but is not limited to, a flight plan for the flight of the aircraft, where the flight plan includes identification of a flight path and identification of a region extending laterally from a centerline of the flight path. Words extracted from the flight plan can include words scraped from the identification of the region. The size of the region can be determined by a programmable constant distance from the centerline of the flight path in all directions. Other constructions of regions can include, but are not limited to, a constant distance from the flight path in all directions, or a varying distance from the flight path or the centerline in selected directions.

Variations of aviation system 900 and its features, or similar systems, can include a set of extracted words having one or more of aviation locations along a path identified for the flight, a call sign of the aircraft corresponding to a flight being monitored, or variations to the call sign of the aircraft. Aviation system 900 can include a database, such as storage 940, having data providing a variety of information regarding one or more entities in the flight plan.

Aviation system 900 can be structured to automatically perform an action in response to analysis of the recognized speech input by making a recommendation affecting flight of the aircraft. The recommendation can be displayed on a screen in the aircraft or by generation of the recommendation audibly using a speaker in the aircraft. Variations can include aviation system 900 arranged in an ATC center. Aviation system 900 can be structured to operate one or more of features as disclosed herein.

In various embodiments, a machine-readable storage device can be implemented storing instructions that, when executed by one or more processors, can cause a machine to perform operations associated with a speech recognition system for an aviation system. The operations can comprise operations to receive state information of an aircraft or intent information of the aircraft. Words from the state information or the intent information can be extracted, where the extracted words can include aviation words specific to a flight of the aircraft. A vocabulary of a speech recognition algorithm of a speech recognition system with the extracted words can be boosted.

Variations of the machine-readable storage can include machine-readable storage having executable instructions to augment a control system of an aviation system with the speech recognition algorithm having the boosted stored aviation vocabulary, where the control system is associated with the state information or the intent information. The state information can include, but is not limited to, one or more of current location of the aircraft in the flight, selected radio frequency, global positioning system information, or heading of the aircraft in the flight. The intent information can include a flight plan of the flight of the aircraft. Operations can include operations to add data to the speech recognition system, where the data is information of one or more entities in the flight plan.

Such machine-readable storage device and associated processors can be implemented in a number of different aviation systems, as taught herein. Extracted words from a flight plan can include, but are not limited to, aviation locations along a path identified in the flight plan, a call sign of the aircraft corresponding to the flight plan, or variations to the call sign of the aircraft corresponding to the flight plan.

For such a speech recognition system of an aviation system, the operations of the speech recognition system of the aviation system can include receiving speech input at a receiver input of the speech recognition system containing the speech recognition algorithm, where the speech recognition system is coupled to a control system of the aviation system. Operations can include recognizing, by the speech recognition system, the speech input using words extracted using state information of the aircraft or intent information of the aircraft associated with the received speech input. Operations can include analyzing, in the control system, the recognized speech input with respect to the flight of the aircraft and automatically performing an action in the control system in response to analyzing the recognized speech input, where the action is associated with the flight of the aircraft.

Operations can include performing the action in the control system by making a recommendation affecting the flight of the aircraft, by displaying the recommendation on a screen in the aircraft or by generating the recommendation audibly using a speaker in the aircraft. Additional operations can include operations to perform features associated with an aviation system as taught herein.

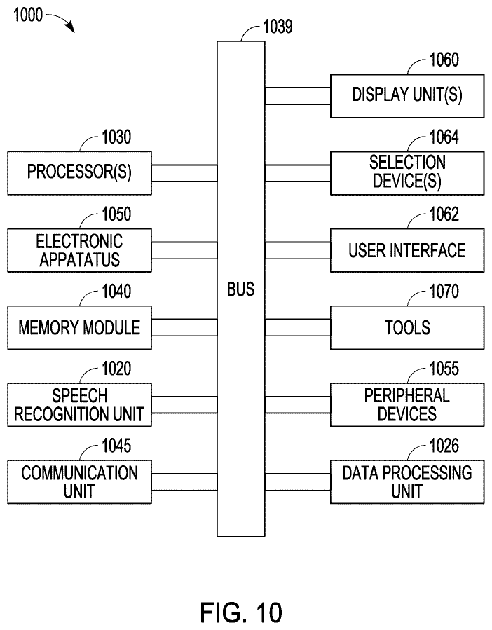

FIG. 10 depicts a block diagram of features of an embodiment of an example system 1000 operable to control its operation in conjunctions with a speech recognition unit 1020, as described herein or in a similar manner. Speech recognition unit 1020 can be implemented using a speech recognition algorithm modified by words extracted using state information of an aircraft or intent information of an aircraft associated with flight of the specified aircraft.

System 1000 can include one or more processors 1030, a memory module 1040, electronic apparatus 1050, and a communications unit 1045. Memory module 1040 can be structured to include a database. One or more processors 1030, memory module 1040, and communications unit 1045 can be arranged to operate as a control unit to control operation of tools 1070 that perform functions of system 1000. One or more processors 1030, structured to control operations of tools 1070 in response to output from speech recognition unit 1020 can be implemented as a single unit or distributed among the components of system 1000 including electronic apparatus 1050. One or more processors 1030, speech recognition unit 1020, and other components of system 1000 can be configured, for example, to operate similar to or identical to the components discussed herein or similar to or identical to any of the methods regarding aviation activities discussed herein.

Communications unit 1045 can use combinations of wired communication technologies and wireless technologies at various frequencies to receive state information or intent information of an aircraft. The information can be provided from data scraping using one or more components of system 1000 such as one or more processors 1030 or a data processing unit 1026. System 1000 can also include a bus 1039, where bus 1039 provides communication conductivity among the components of system 1000. Bus 1039 can be realized using a number of different communication mediums that allows for the distribution of components of system 1000. Use of bus 1039 can be regulated by one or more processors 1030.

Peripheral devices 1055 can include additional storage memory and other control devices that may operate in conjunction with one or more processors 1030 and memory module 1040. One or more processors 1030 can be realized as a processor or a group of processors that may operate independently depending on an assigned function.

System 1000 can include display unit(s) 1060 as a distributed component, which can be used with instructions stored in memory module 1040 to implement a user interface 1062 to monitor the operation of tools 1070 or components distributed within system 1000. User interface 1062 may be used to input parameter values for thresholds such that system 1000 can operate autonomously substantially without user intervention or to provide recommendations for further operation of system 1000 to execute a flight-specific operation of an aircraft in response to speech input recognized by speech recognition unit 1020 using words extracted using state information or intent information of an aircraft state information or intent information of an aircraft. User interface 1062 can also provide for manual override and change of control of system 1000 to a user. User interface 1062 can be operated in conjunction with one or more selection devices 1064, communications unit 1045, and bus 1039.

The following examples are example embodiments of systems and methods, in accordance with the teachings herein.

An example aviation system 1 can comprise an audio receiver to receive speech input; a speech recognition subsystem responsive to the speech input received at the audio receiver, the speech recognition subsystem configured to recognize the speech input using words extracted using state information of an aircraft or intent information of the aircraft associated with the received speech input; and a control subsystem to automatically perform an action in the aviation system in response to analysis of the recognized speech input, the action associated with flight of the aircraft.

An example aviation system 2 can include features of example aviation system 1 and can include the extracted words to include one or more of aviation locations along a path identified in a flight plan, a call sign of the aircraft corresponding to the flight plan, or variations to the call sign of the aircraft corresponding to the flight plan.

An example aviation system 3 can include features of any of the preceding example aviation systems and can include the intent information to include a flight plan for the flight of the aircraft, the flight plan including identification of a flight path and identification of a region extending laterally from a centerline of the flight path, and words extracted from the flight plan include words scraped from the identification of the region.

An example aviation system 4 can include features of any of the preceding example aviation systems and can include the action to include a recommendation affecting flight of the aircraft, by a display of the recommendation on a screen in the aircraft or by an audible generation of the recommendation using a speaker in the aircraft.

In an example aviation system 5, any of the aviation systems of example aviation systems 1 to 4 may include an electronic apparatus further comprising a host processor and a communication bus extending between the host processor and the aviation system.

In an example aviation system 6, any of the aviation systems of example aviation systems 1 to 5 may be modified to include any structure presented in another of example aviation system 1 to 5.

In an example aviation system 7, any apparatus associated with the aviation systems of example aviation systems 1 to 6 may further include a machine-readable storage device configured to store instructions as a physical state, wherein the instructions may be used to perform one or more operations of the apparatus.

In an example aviation system 8, any of the aviation systems of example aviation systems 1 to 7 may be operated in accordance with any of the below example methods 1 to 23 and example methods 1 to 10 of operating a speech recognition system.

An example method 1 can comprise: receiving speech input at a receiver input of a speech recognition subsystem of an aviation system; recognizing, by the speech recognition subsystem, the speech input using words extracted using state information of an aircraft or intent information of the aircraft associated with the received speech input; analyzing, in the aviation system, the recognized speech input with respect to flight of the aircraft; and performing, automatically, an action in the aviation system in response to analyzing the recognized speech input, the action associated with the flight of the aircraft.

An example method 2 can include features of example method 1 and can include data scraping a graphical representation of a flight plan to extract the words from the flight plan.

An example method 3 can include features of any of the preceding example methods and can include boosting weights associated with the extracted words in a speech recognition algorithm of the speech recognition subsystem.

An example method 4 can include features of any of the preceding example methods and can include automatically performing the action to include performing, automatically, an action in the aviation system to control flight of the aircraft in response to analyzing the recognized speech input.

An example method 5 can include features of any of the preceding example methods and can include the extracted words to include aviation locations along a path identified in a flight plan, a call sign of the aircraft corresponding to the flight plan, or call signs of other aircraft within a specified radius about a selected location.

An example method 6 can include features of example method 5 and any of the preceding example methods and can include the extracted words to include aviation locations in a local region in which a flight path for the aircraft is located, the flight path identified in a flight plan.

An example method 7 can include features of any of the preceding example methods and can include performing the action in the aviation system to include making a recommendation affecting flight of the aircraft, by displaying the recommendation on a screen in the aircraft or by generating the recommendation audibly using a speaker in the aircraft

An example method 8 can include features of example method 7 and any of the preceding example methods and can include performing the recommendation in response to a signal to perform the recommendation, the signal being a speech signal or an instrument-actuated signal.

An example method 9 can include features of example method 7 and any of the preceding example methods and can include altering the flight of the aircraft by a control subsystem of the aircraft in response to speech recognition of a command based on the recommendation, details of the altered flight generated from words extracted from a flight plan.

In an example method 10, any of the example methods 1 to 9 may be performed in forming an electronic apparatus further comprising a host processor and a communication bus extending between the host processor and the system.

In an example method 11, any of the example methods 1 to 10 may be modified to include operations set forth in any other of example methods 1 to 10.

In an example method 12, any of the example methods 1 to 11 may be implemented at least in part through use of instructions stored as a physical state in one or more machine-readable storage devices.

An example method 13 can include features of any of the preceding example methods 1 to 12 and can include performing functions associated with any features of example systems 1 to 8.

An example method 1 of operating a speech recognition system can comprise: receiving state information of an aircraft or intent information of the aircraft; extracting words using the state information or the intent information, the extracted words including aviation words specific to a flight of the aircraft; and boosting a vocabulary of a speech recognition algorithm of the speech recognition system with the extracted words.

An example method 2 of operating a speech recognition system can include features of example method 1 of operating a speech recognition system and can include boosting the vocabulary in an aviation system in the aircraft during the flight.

An example method 3 of operating a speech recognition system can include features of any of the preceding example methods of operating a speech recognition system and can include extracting words using the intent information to include extracting words from a flight plan for the flight including extracting aviation locations along a path identified in the flight plan, a call sign of the aircraft, or call signs of other aircraft in a vicinity of a flight path of the flight plan.

An example method 4 of operating a speech recognition system can include features of any of the preceding example methods of operating a speech recognition system and can include extracting words to include extracting words during the flight identifying a flight path for the aircraft and words identifying a region extending laterally from the flight path.

An example method 5 of operating a speech recognition system can include features of example method 4 of operating a speech recognition system and any of the preceding example methods of operating a speech recognition system and can include extracting words to include extracting words for identifying an alternative flight path for the aircraft different from a flight path specified in a flight plan.

An example method 6 of operating a speech recognition system can include features of example method 4 of operating a speech recognition system and any of the preceding example methods of operating a speech recognition system and can include adding data to the speech recognition system, the data being information regarding one or more entities in a flight plan of the flight of the aircraft.

In an example method 7 of operating a speech recognition system, any of the example methods 1 to 6 of operating a speech recognition system may be performed in structuring an electronic apparatus further comprising a host processor and a communication bus extending between the host processor and the speech recognition system.

In an example method 8 of operating a speech recognition system, any of the example methods 1 to 7 of operating a speech recognition system may be modified to include operations set forth in any other of example methods 1 to 7 of operating a speech recognition system.

In an example method 9 of operating a speech recognition system, any of the example methods 1 to 8 of operating a speech recognition system may be implemented at least in part through use of instructions stored as a physical state in one or more machine-readable storage devices.

An example method 10 of operating a speech recognition system can include features of any of the preceding example methods 1 to 9 of operating a speech recognition system and can include performing functions associated with any features of example memory devices 1 to 8.

An example machine-readable storage device storing instructions that, when executed by one or more processors, cause a machine to perform operations, can comprise instructions to perform functions associated with any features of example memory devices 1 to 8 or perform methods associated with any features of example methods 1 to 13 and example methods 1 to 10 of operating a speech recognition system.

An example machine-readable storage device 1 storing instructions that, when executed by one or more processors, cause a machine to perform operations, the operations comprise: receiving state information of an aircraft or intent information of the aircraft; extracting words using the state information or the intent information, the extracted words including aviation words specific to a flight of the aircraft; and boosting a vocabulary of a speech recognition algorithm of a speech recognition system with the extracted words.

An example machine-readable storage device 2 can include features of example machine-readable storage device 1 and can include the operations to include the state information to include one or more of current location of the aircraft in the flight, selected radio frequency, global positioning system information, or heading of the aircraft in the flight.

An example machine-readable storage device 3 can include features of any of the preceding example machine-readable storage devices and can include the intent information to include a flight plan of the flight of the aircraft.

An example machine-readable storage device 4 can include features of any of the preceding example machine-readable storage devices and can include the extracted words to include aviation locations along a path identified in a flight plan, a call sign of the aircraft corresponding to the flight plan, or variations to the call sign of the aircraft corresponding to a flight plan.

An example machine-readable storage device 5 can include features of any of the preceding example machine-readable storage devices and can include the operations to include: receiving speech input at a receiver input of the speech recognition system containing the speech recognition algorithm, the speech recognition system coupled to a control system of an aviation system; recognizing, by the speech recognition system, the speech input using words extracted using state information of the aircraft or intent information of the aircraft associated with the received speech input; analyzing, in the control system, the recognized speech input with respect to the flight of the aircraft; and performing, automatically, an action in the control system in response to analyzing the recognized speech input, the action associated with the flight of the aircraft.

An example machine-readable storage device 5 can include features of example machine-readable storage device 4 and any of the preceding example systems and can include performing the action in the control system to include making a recommendation affecting the flight of the aircraft, by displaying the recommendation on a screen in the aircraft or by generating the recommendation audibly using a speaker in the aircraft.

Although specific embodiments have been illustrated and described herein, it will be appreciated by those of ordinary skill in the art that any arrangement that is calculated to achieve the same purpose can be substituted for the specific embodiments shown. Various embodiments use permutations or combinations of embodiments described herein. It is to be understood that the above description is intended to be illustrative, and not restrictive, and that the phraseology or terminology employed herein is for the purpose of description.

What is claimed is:

1. An aviation system comprising:
an audio receiver to receive speech input;
a speech recognition subsystem responsive to the speech input received at the audio receiver, the speech recognition subsystem configured to recognize the speech input using words extracted using state information of an aircraft or intent information of the aircraft associated with the received speech input; and
a control subsystem to automatically perform an action in the aviation system in response to analysis of the recognized speech input, the action associated with flight of the aircraft.

2. The aviation system of claim 1, wherein the extracted words include one or more of aviation locations along a path identified in a flight plan, a call sign of the aircraft corresponding to the flight plan, or variations to the call sign of the aircraft corresponding to the flight plan.

3. The aviation system of claim 1, wherein the intent information includes a flight plan for the flight of the aircraft, the flight plan including identification of a flight path and identification of a region extending laterally from a centerline of the flight path, and words extracted from the flight plan include words scraped from the identification of the region.

4. The aviation system of claim 1, wherein the action includes a recommendation affecting flight of the aircraft, by a display of the recommendation on a screen in the aircraft or by an audible generation of the recommendation using a speaker in the aircraft.

5. A method comprising:
receiving speech input at a receiver input of a speech recognition subsystem of an aviation system;
recognizing, by the speech recognition subsystem, the speech input using words extracted using state information of an aircraft or intent information of the aircraft associated with the received speech input;
analyzing, in the aviation system, the recognized speech input with respect to flight of the aircraft; and
performing, automatically, an action in the aviation system in response to analyzing the recognized speech input, the action associated with the flight of the aircraft.

6. The method of claim 5, wherein the method includes data scraping a graphical representation of a flight plan to extract the words from the flight plan.

7. The method of claim 5, wherein the method includes boosting weights associated with the extracted words in a speech recognition algorithm of the speech recognition subsystem.

8. The method of claim 5, wherein automatically performing the action includes performing, automatically, an action in the aviation system to control flight of the aircraft in response to analyzing the recognized speech input.

9. The method of claim 5, wherein the extracted words include aviation locations along a path identified in a flight plan, a call sign of the aircraft corresponding to the flight plan, or call signs of other aircraft within a specified radius about a selected location.

10. The method of claim 5, wherein the extracted words include aviation locations in a local region in which a flight path for the aircraft is located, the flight path identified in a flight plan.

11. The method of claim 5, wherein performing the action in the aviation system includes making a recommendation affecting flight of the aircraft, by displaying the recommendation on a screen in the aircraft or by generating the recommendation audibly using a speaker in the aircraft.

12. The method of claim 11, wherein the method includes performing the recommendation in response to a signal to perform the recommendation, the signal being a speech signal or an instrument-actuated signal.

13. The method of claim 11, wherein the method includes altering the flight of the aircraft by a control subsystem of the aircraft in response to speech recognition of a command based on the recommendation, details of the altered flight generated from words extracted from a flight plan.

14. A method of operating a speech recognition system, the method comprising:
receiving state information of an aircraft or intent information of the aircraft;
extracting words using the state information or the intent information, the extracted words including aviation words specific to a flight of the aircraft; and
boosting a vocabulary of a speech recognition algorithm of the speech recognition system with the extracted words.

15. The method of claim 14, wherein the method includes boosting the vocabulary in an aviation system in the aircraft during the flight.

16. The method of claim 14, wherein extracting words using the intent information includes extracting words from a flight plan for the flight including extracting aviation locations along a path identified in the flight plan, a call sign of the aircraft, or call signs of other aircraft in a vicinity of a flight path of the flight plan.

17. The method of claim 14, wherein extracting words includes extracting words during the flight identifying a flight path for the aircraft and words identifying a region extending laterally from the flight path.

18. The method of claim 17, wherein extracting words includes extracting words for identifying an alternative flight path for the aircraft different from a flight path specified in a flight plan.

19. The method of claim 17, wherein the method includes adding data to the speech recognition system, the data being information regarding one or more entities in a flight plan of the flight of the aircraft.

20. A machine-readable storage device storing instructions that, when executed by one or more processors, cause a machine to perform operations, the operations comprise:
receiving state information of an aircraft or intent information of the aircraft;
extracting words using the state information or the intent information, the extracted words including aviation words specific to a flight of the aircraft; and
boosting a vocabulary of a speech recognition algorithm of a speech recognition system with the extracted words.

21. The machine-readable storage device of claim 20, wherein the state information includes one or more of current location of the aircraft in the flight, selected radio frequency, global positioning system information, or heading of the aircraft in the flight.

22. The machine-readable storage device of claim 20, wherein the intent information includes a flight plan of the flight of the aircraft.

23. The machine-readable storage device of claim 20, wherein the extracted words extracted include aviation locations along a path identified in a flight plan, a call sign of the aircraft corresponding to the flight plan, or variations to the call sign of the aircraft corresponding to a flight plan.

24. The machine-readable storage device of claim 20, wherein the operations include:
receiving speech input at a receiver input of the speech recognition system containing the speech recognition algorithm, the speech recognition system coupled to a control system of an aviation system;
recognizing, by the speech recognition system, the speech input using words extracted using state information of the aircraft or intent information of the aircraft associated with the received speech input; and
analyzing, in the control system, the recognized speech input with respect to the flight of the aircraft; and
performing, automatically, an action in the control system in response to analyzing the recognized speech input, the action associated with the flight of the aircraft.

25. The machine-readable storage device of claim 24, wherein performing the action in the control system includes making a recommendation affecting the flight of the aircraft, by displaying the recommendation on a screen in the aircraft or by generating the recommendation audibly using a speaker in the aircraft.
